(19) United States
(12) Patent Application Publication
(10) Pub. No.: US 2024/0175770 A1
(43) Pub. Date: May 30, 2024

(54) SUPPORT JACK COMPRISING A SUPPORT FOOT AND A FORCE MEASURING ELEMENT

(71) Applicant: JOST-WERKE DEUTSCHLAND GMBH, Neu-Isenburg (DE)

(72) Inventors: José Manuel ALGÜERA, Aschaffenburg (DE); Günter SEIDEL, Riedstadt (DE)

(21) Appl. No.: 18/551,914

(22) PCT Filed: Mar. 25, 2022
(86) PCT No.: PCT/IB2022/052775

§ 371 Date: Sep. 22, 2023

(30) Foreign Application Priority Data
Mar. 25, 2021 (DE) 102021001552.5

(51) Int. Cl. G01L 5/00; B60S 9/02

(52) U.S. Cl. CPC G01L 5/0004; B60S 9/02

(57) ABSTRACT

A support jack including a support foot and a force measuring element, wherein the support jack has an outer tube and an inner tube movably mounted therein, and the support foot the force measuring element is attached to the foot receiving element is pivotally secured to the inner tube by a foot receiving element. The support allows a quantitative and reproducible measurement of the forces transmitted by the support jack to the underlying surface. This is achieved in that the force measuring element is attached to the foot receiving element.

### FIELD OF THE INVENTION

The invention relates to a support jack comprising a support foot and a force measuring element, wherein the support jack has an outer tube and an inner tube movably mounted therein, and the support foot is pivotably secured to the inner tube by means of a foot receiving element.

### BACKGROUND OF THE INVENTION

Such support jacks are often attached to semi-trailers or trailers in general and support them on the ground, particularly when uncoupled from the towing vehicle. As a result, the semi-trailer maintains a stable position in its parking position and can be approached by a towing vehicle to be coupled again. In other applications, the support jacks are arranged at the rear of silo vehicles and are extended to stabilize the vehicle before the tipping process is initiated.

From DE 10 2005 036 139 A1 a support jack comprising a pressure element and a support load indicator has become known, which shows the operator a safe position when extending the support jacks. The pressure element comprises a spring element and a switching element interacting therewith in the form of a mechanical button, the spring element being arranged between a spindle stop ring arranged in a stationary manner on the spindle and the spindle bearing plate. When the support jack is extended, the spindle moves against the spindle bearing plate if the surface is stable, so that the spring element is deformed and the switching element is actuated. The switching element in turn is connected to a display element which indicates to the operator the presence of a loaded support jack. However, it has proven to be disadvantageous that the spring element does not deliver reproducible values after frequent load changes and therefore triggers the switching element even if the force is applied too low. Furthermore, the support load indicator cannot be used to make any quantitative statements about the forces transmitted by the support jack.

Consequently, the invention was based on the object of providing a support jack that enables a quantitative and reproducible measurement of the forces transmitted from the support jack to the ground.

### SUMMARY OF THE INVENTION

The object is achieved according to the invention with the features of the force measuring element being attached to the foot receiving element. With a force measuring element attached to the foot receiving element, it can be determined whether a trailer to be uncoupled is safely parked and, particularly in the case of a semi-trailer, the support jacks have firm contact with the ground. In addition to this qualitative determination, there is also a quantitative determination of the load acting on the support jack. This makes it possible to determine the total weight of the trailer by recording the axle loads and thereby determine potential overloading or uneven load distribution.

The foot receiving element is a component arranged in the flow of force between the support foot and the inner tube of the support jack. Typically, the foot receiving element is firmly connected to the inner tube, in particular welded. As a result, the inner tube is additionally stiffened at its lower end by the foot receiving element.

A force measuring element is a sensor that generates a signal proportional to the force introduced from a deformation of the foot receiving element. These are, for example, piezoelectric sensors that detect the change in electrical polarization and thus the occurrence of an electrical voltage on solid bodies when they are elastically deformed. Alternatively, capacitive sensors can also be used.

The force measuring element is attached to the foot receiving element, with fastening of the force measuring element within the foot receiving element or on the surface of the foot receiving element being preferred. All fastening positions have in common that the force measuring element is connected to the foot receiving element in such a way that it detects its deformation as precisely as possible, with a non-positive, material and/or positive connection being particularly suitable, in particular through precise clamping or gluing. Using the force measuring element, a force can be determined depending on the deformation of the foot receiving element.

According to a first preferred embodiment, the foot receiving element has a main body, with which the foot receiving element is fastened to the inner tube, and two bearing pins projecting on opposite sides of the main body. The main body can be shaped to complement the inner contour of the inner tube, inserted into the inner tube from below and preferably connected to it in a materially bonded manner. In the axial direction, at least a lower section of the inner tube overlaps the main body inserted therein, which increases the overall wall thickness in the area of the loads introduced by the support foot. The bearing pins engage, for example, on the main body. Particularly preferred is an embodiment in which the bearing pins and the main body form a one-piece, integral structural unit. The support foot is pivotally attached to the bearing pins.

According to a second, alternative embodiment, the foot receiving element has an axle tube which projects laterally beyond the inner tube and to which the support foot is pivotally attached. The axle tube can be a hollow body or a solid body. The inner tube can be provided with corresponding, aligned openings to accommodate the axle tube. It is also possible to insert the axle tube into separate bearing sleeves, which in turn are firmly connected to the inner tube and aligned with one another.

The bearing sleeves can be inserted into openings in the inner tube or connected from below to the front end of the inner tube.

The force measuring element can then be attached to the main body, to one of the bearing pins or the axle tube.

The force measuring element can in particular be pin-shaped and inserted into a complementary shaped recess of the foot receiving element without play or under prestress.

Particularly useful is an embodiment in which the pin-shaped force measuring element is a measuring dowel and the recess is a measuring dowel bore into which the measuring dowel is inserted. A measuring dowel is understood to mean a sensor that is force-sensitive in the transverse direction, which is typically designed with a cylindrical shape and is always inserted with a precise fit and/or under pre-tensioning into a complementary shaped measuring dowel bore in the component to be measured, or at least when the expected operating load is present. The pre-tensioning of the measuring dowel is realized, for example, by means of a clamping device integrated into the measuring dowel. The diameter of the measuring dowel bore is typically 6.00 mm to 10.00 mm, particularly preferably 8 mm.

According to a particularly useful embodiment, the measuring dowel is mechanically clamped in the measuring dowel bore. This allows the measuring dowel to be removed from the measuring dowel bore and reinserted for maintenance and repair purposes. Replacing the measuring dowel would involve much more effort if the connection was cast or glued within the measuring dowel bore.

The recess is advantageously arranged in one of the bearing pins or the axle tube. Both components directly absorb the forces transmitted by the support foot and are therefore subject to a change in shape under load, which is detected by the pin-shaped force measuring element.

The recess is advantageously aligned in the axial direction of the bearing pin or the axle tube. This results in the advantage that the pin-shaped force measuring element is exposed to a bending stress on the bearing pin or axle tube when the support foot is standing on the ground and a particularly precise measurement of the force acting on the support jack is possible. The measurement accuracy can be improved even further if the recess is arranged eccentrically to the central axis of the bearing pin or axle tube, on a side facing away from the outer and/or inner tube. In this area, the bearing pin or the axle tube undergoes stretching, the amount of which increases with increasing eccentricity, which further improves the measurement accuracy.

The recess is expediently formed as a blind hole on one front side of the bearing pin or the axle tube. This makes it possible to position the pin-shaped force measuring element in an area of the greatest applied forces without weakening the bearing pin or the axle tube through an unnecessarily long recess.

Advantageously, the pin-shaped force measuring element is inserted into the deepest part of the blind hole. This results in a particularly protected mounting position of the pin-shaped force measuring element.

The support foot can have a base plate, on which two wall sections are formed projecting laterally with respect to the inner tube, wherein a bearing opening is formed in the wall sections for receiving the bearing pins or the axle tube, at least a section of the pin-shaped force measuring element being arranged between the adjacent wall section and a downwardly projected plane of the inner tube.

The flow of force takes place from the support foot via the wall sections to the bearing pins or the axle tube and from there, if necessary, via the main body to the inner tube. In an area between the wall section and the inner tube or its downward extension, the bearing pin or the axle tube to be monitored by means of the pin-shaped force measuring element undergoes the greatest deformation, which enables particularly precise measurements of the pin-shaped force measuring element.

According to a further, alternative embodiment, the force measuring element is a strain gauge application. The strain gauge application is used to record stretching and compressing deformations of the foot receiving element. It changes its electrical resistance even with small deformations and is used as a strain sensor. Typically, the strain gauge application is glued to the foot receiving element, which deforms minimally under load. Its deformation under load then leads to a change in the electrical resistance of the strain gauge application.

It is preferred to attach the strain gauge application to an upper and/or lower side of the main body. This results in the advantage, on the one hand, that no weakening of the foot receiving element has to be carried out through drilling or milling and, on the other hand, that there is an expansion or compression on the upper side and lower side of the main body and thereby particularly precise and reproducible measured values can be achieved. Since the strain gauge application is regularly located on the surface of the component to be monitored, attachment to the main body is preferred, in particular to its upper side, which is protected in the inner tube.

As an alternative to the embodiment described above, the strain gauge application can be applied to the axle tube and detect its deformation under load.

### BRIEF DESCRIPTION OF THE DRAWINGS

For better understanding, the invention is explained in more detail below using six figures, showing in

FIG. 1: a longitudinal section through a support jack comprising a support foot mounted on it;

FIG. 2: a longitudinal section rotated by 90° through the lower section of the support jack according to FIG. 1 with a force measuring element according to a first embodiment;

FIG. 3: a side view of the lower section of the support jack according to FIG. 1;

FIG. 4: a schematic longitudinal section through a support jack with a force measuring element according to a second embodiment;

FIG. 5: a schematic longitudinal section through a support jack with a force measuring element according to a third embodiment and

FIG. 6: a schematic longitudinal section through a support jack with a force measuring element according to a fourth embodiment.

### DETAILED DESCRIPTION OF THE INVENTION

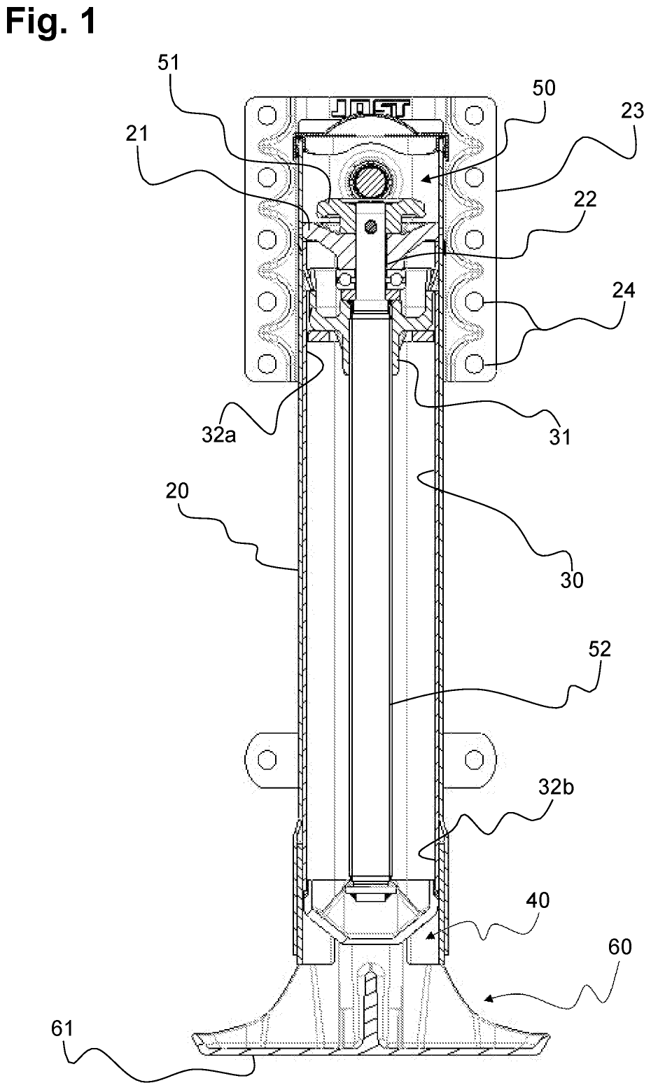

FIG. 1 shows a longitudinal section of a support jack having an outer tube 20 in the form of a square profile and an inner tube 30 guided axially therein.

Due to the complementary profile shape of the outer and inner tubes 20, 30, the inner tube 30 is held in the outer tube 20 in a rotationally fixed manner in the circumferential direction.

To attach the support jack to a vehicle, a mounting flange plate 23 protrudes on both sides of the outer tube 20, wherein mounting holes 24 are made at discrete intervals in the mounting flange plate 23. The inner tube 30 carries a support foot 60 at its lower end, with which the support jack stands on the ground when the inner tube 30 is extended.

Arranged in the outer tube 20 is a gear arrangement 50 with a spindle 52 which is rotatably mounted relative to the outer tube 20 and a gear 51 which is connected to the spindle 52 in a rotationally fixed manner at an upper end section. By rotating the spindle 52, a spindle nut 31 firmly inserted into an upper section 32a of the inner tube 30 moves either downwards or upwards, depending on the direction of rotation. When the spindle nut 31 moves downward, the inner tube 30 and the support foot 60 attached to it are pushed towards the ground and the support jack is extended. When the spindle nut 31 moves upwards, the inner tube 30 is lifted together with the support foot 60 and the support jack is retracted.

The spindle 52 passes through a spindle bearing plate 21 arranged under the gear 51, wherein the spindle bearing plate 21 is formed with a spindle opening 22 whose inner diameter is selected to be only slightly larger than the outer diameter of the spindle 52. By means of the spindle bearing plate 21 and the spindle opening 22, the spindle 52 is supported in its radial direction. The spindle bearing plate 21 is firmly connected to the inner wall of the outer tube 20 on at least three sides, preferably on four sides. The spindle bearing plate 21 is oriented substantially orthogonal to the extent of the outer tube 20. The spindle 52 and the associated spindle opening 22 in the spindle bearing plate 21 are housed centrally in the outer tube 20.

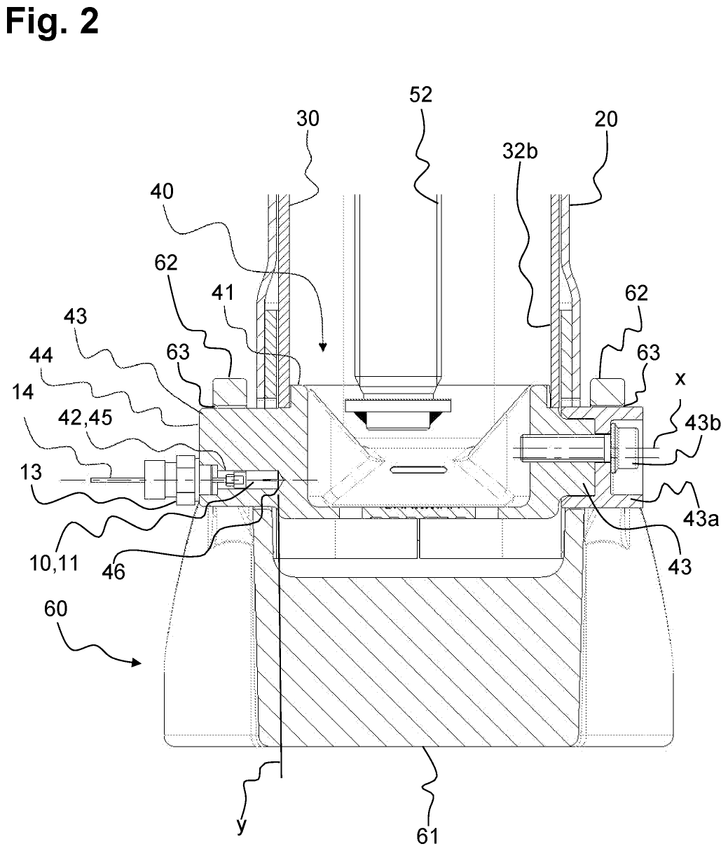

FIG. 2 shows a lower section 32b of the inner tube 30 with the support foot 60 attached thereto. The support foot 60 is pivotally mounted on a foot receiving element 40, which in turn is fixed in a stationary manner on the inner tube 30 in the area of the lower section 32b. In the exemplary embodiment shown, the foot receiving element 40 has a main body 41 and two bearing pins 43 projecting on opposite sides with respect to the inner tube 30. The bearing pins 43 project laterally outward under the inner tube 30 and/or outer tube 20.

The main body 41 is formed with a shape that is complementary to the inner contour of the inner tube 30, is inserted into the inner tube 30 from below at the end face and is permanently connected to it. In the maximum raised position of the inner tube 30, the bearing pins 43 abut the end face of the outer tube 20. Typically, the main body 41 at least partially overlaps the inner tube 30 from the inside and protrudes downward from it.

The support foot 60 comprises a substantially flat base plate 61, on which two vertical wall sections 62 are formed. The inner tube 30 and the outer tube 20 are arranged between the two wall sections 62. Each wall section 62 has a mutually aligned bearing opening 63, through which the bearing pins 43 of the foot receiving element 40 extend, wherein the bearing pin 43 on the right in the image plane is of two-part construction for simplified mounting of the support foot 60 on the foot receiving element 40 and has a detachable assembly end piece 43a, which is fastened to the bearing pin 43 by means of a screw 43b. When the support foot 60 is mounted on the foot receiving element 40, the support foot 60 swings about a central axis x of the bearing pin 43.

A recess 42 running parallel to the central axis x is introduced into a front side 44 of one of the two bearing pins 43, which can be a measuring dowel bore 42, for example.

In the present exemplary embodiment, the recess 42 is designed as a blind hole 45, the borehole deepest 46 of which extends to a downwardly extending, projected plane y in an extension of the inner tube 30. A force measuring element 10 in the form of a pin-shaped force measuring element 10, in particular a measuring dowel 11, is inserted in a stationary manner into the recess 42 and clamped within the recess 42 relative to the associated bearing pin 43.

The position of the pin-shaped force measuring element 10 is in the area between the nearest wall section 62 and the borehole deepest 46. When the inner tube 30 is extended relative to the outer tube 20 and the support foot 60 is standing on the ground, a force flow occurs from the support foot 60 via the bearing pins 43 to the inner tube 30. As a result, the bearing pin 43 between the wall section 62 and the main body 41 is subject to a bending stress and a relatively large deformation occurs, which enables precise measurement by means of the pin-shaped force measuring element 10 and the measured value of which can be assigned to a corresponding support load.

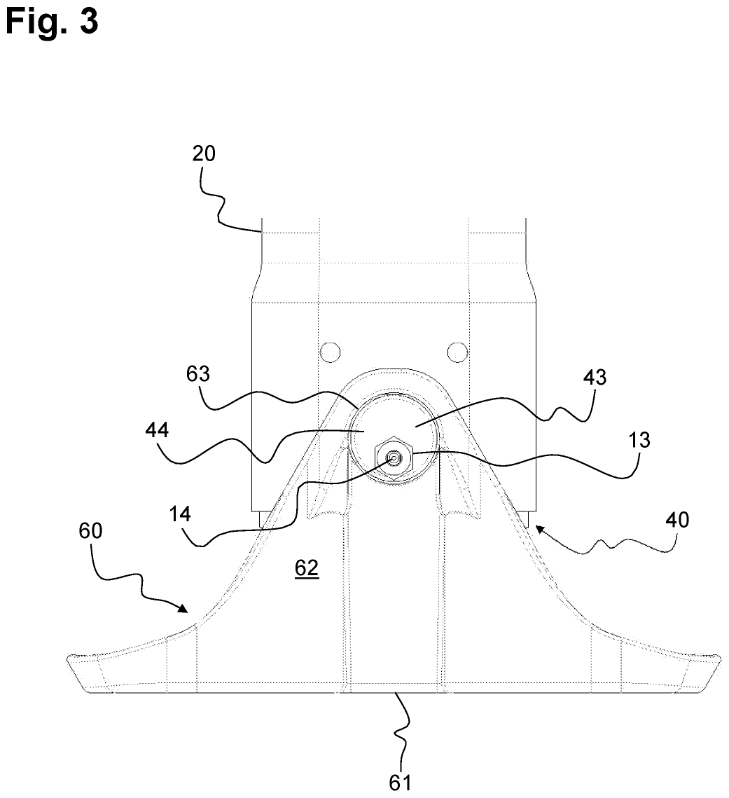

In FIG. 3, a lateral overlap of the wall section 62 with the outer tube 20 and the inner tube 30 can be seen particularly well in the retracted position of the support jack. In the extended position of the support jack, the wall sections 62 only overlap with the inner tube 30.

Both FIGS. 2 and 3 show the eccentric orientation of the force measuring element 10 within the bearing pin 43. Due to the bending stress under load, the force measuring element 10 is located on a side of the bearing pin 43 facing the base plate 61, which is subject to greater elongation with increasing eccentricity to the center axis x.

A transition coupling 13 is inserted into an open end of the recess 42, with the aid of which the recess 42 is closed to the outside and through which only a connecting cable 14 is led out of the recess 42. The force measuring element 10 is electrically connected via the connecting cable 14 to an on-board network of a vehicle, not shown here, from which the force measuring element 10 is supplied with electrical energy. In addition, the force measuring element 10 provides force measurement signals to the vehicle via the connecting cable 14.

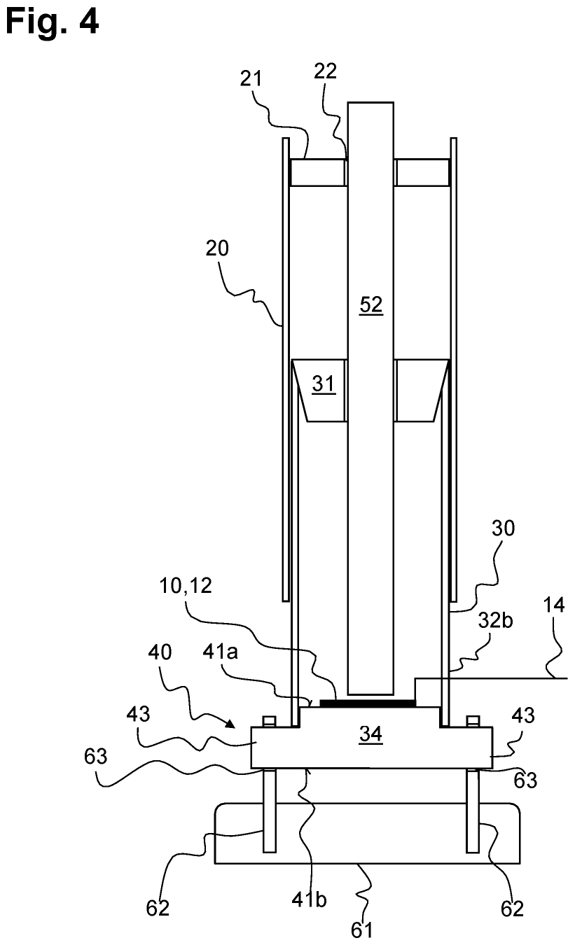

FIG. 4 shows an alternative embodiment with a force measuring element 10 in the form of a strain gauge application 12. The strain gauge application 12 is preferably applied to an upper side 41a of the main body 41 and is located in a protected position within the contour of the inner tube 30. In principle, it would also be possible to attach the strain gauge application 12 to a lower side 41b of the main body 41, which, however, is exposed to considerable environmental influences when driving.

The strain gauge application 12 can be connected to the energy and data system of a vehicle, not shown here, by means of a connection cable 14.

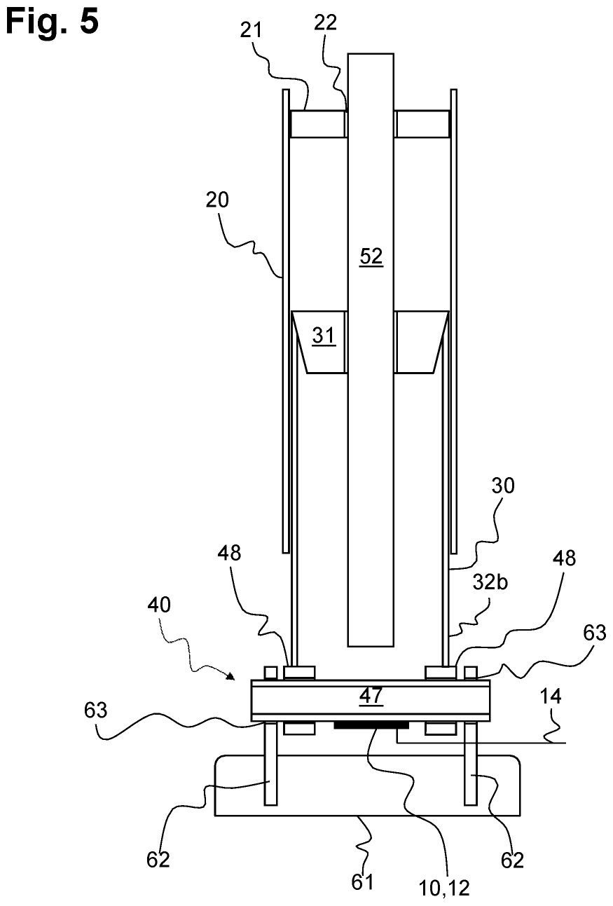

FIG. 5 shows a further embodiment of the support jack, in which the foot receiving element 40 comprises an axle tube 47. The axle tube 47 is a continuous component with a circular cross section. The axle tube 47 passes under opposite wall sections of the inner tube 30 to such an extent that the bearing openings 63 of the wall sections 62 are also penetrated by the axle tube 47. The support foot 60 is pivotally mounted on the axle tube 47.

To stiffen the lower section 32b of the inner tube 30 and to reduce the surface pressure in this area, bearing sleeves 48 are firmly attached to the inner tube 30 in alignment with one another, through which the axle tube 47 is passed. The axial alignment of both bearing sleeves 48 is substantially perpendicular to the axial extent of the inner tube 30.

A force measuring element 10 in the form of a strain gauge application 12 is applied to the surface of the axle tube 47. In the present exemplary embodiment, the strain gauge application 12 is located on a side of the axle tube 47 facing the base plate 61 of the support foot 60. Particularly preferred is an arrangement of the strain gauge application 12 between the wall sections of the inner tube 30, in particular between the two spaced apart bearing sleeves 48.

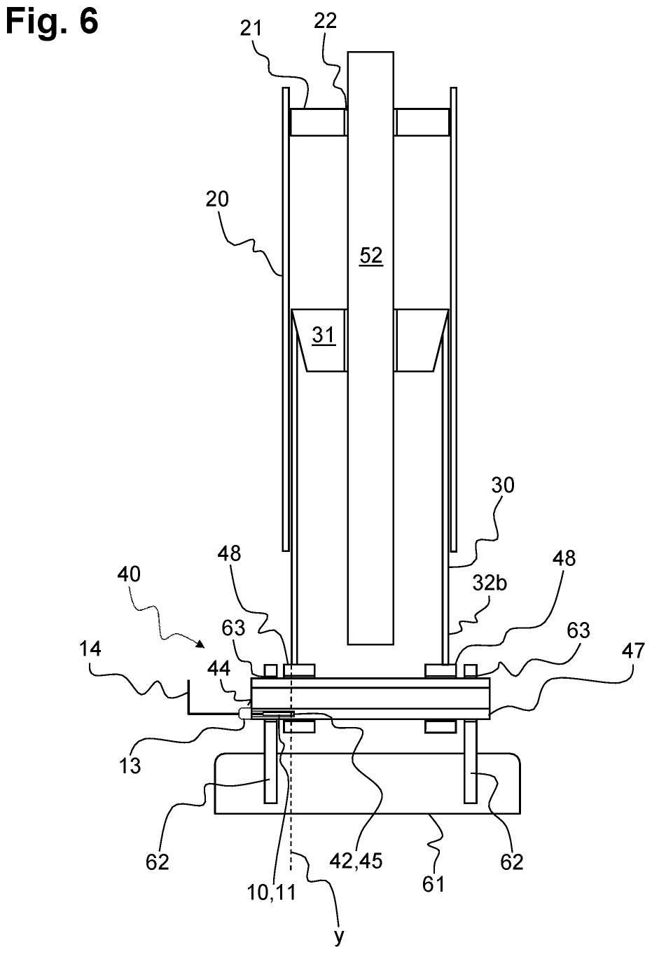

FIG. 6 shows a further exemplary embodiment of the invention with a foot receiving element 40 in the form of an axle tube 47, the wall thickness of which has sufficient thickness to provide a recess 42, in particular a measuring dowel bore 42, therein. A pin-shaped force measuring element 10, in particular a measuring dowel 11, is inserted into the recess 42 and releasably clamped therein. The recess 42 is located on a side of the axle tube 47 that faces the base plate 61.

In addition, the recess 42, which is also designed as a blind hole 45, opens at the front side 44 of the axle tube 47 and ends with its borehole deepest 46 in overlap with the adjacent bearing sleeve 48. In this respect, in this exemplary embodiment at least a section of the pin-shaped force measuring element 10 is located between the wall section 62 of the support foot 60 and a projected plane y in an extension of the inner tube 30.

### LIST OF REFERENCE NUMERALS

10 force measuring element
11 pin-shaped force measuring element, measuring dowel
12 strain gauge application
13 transition coupling
14 connecting cable
20 outer tube
21 spindle bearing plate
22 spindle opening in spindle bearing plate
23 mounting flange plate
24 mounting holes
30 inner tube
31 spindle nut
32a upper section of inner tube
32b lower section of inner tube
40 foot receiving element
41 main body
41a upper side main body
41b lower side main body
42 recess, measuring dowel bore
43 bearing pin
43a assembly end piece
43b screw
44 front side of bearing pin/axle tube
45 blind hole
46 borehole deepest
47 axle tube
48 bearing sleeve of axle tube
50 gear arrangement
51 gear
52 spindle
60 support foot
61 base plate
62 wall section
63 bearing opening
X center axis bearing pin
y projected plane

What is claimed is:

1. A support jack, comprising:
a support foot and
a force measuring element,
wherein the support jack has an outer tube and an inner tube movably mounted therein, and the support foot is pivotably secured to the inner tube by a foot receiving element,
wherein the force measuring element is attached to the foot receiving element.

2. The support jack according to claim 1, wherein a force is determined by the force measuring element as a function of the deformation of the foot receiving element.

3. The support jack according to claim 1, wherein the foot receiving element has a main body, with which the foot receiving element is fastened to the inner tube, and two bearing pins projecting on opposite sides of the main body.

4. The support jack according to claim 3, wherein the foot receiving element has an axle tube which projects laterally beyond the inner tube and to which the support foot is pivotally attached.

5. The support jack according to claim 4, wherein the force measuring element is attached to the main body, to one of the bearing pins or the axle tube.

6. The support jack according to claim 4, wherein the force measuring element is pin-shaped and is inserted into a complementary shaped recess of the foot receiving element without play or under prestress.

7. The support jack according to claim 6, wherein the pin-shaped force measuring element is a measuring dowel and the recess is a measuring dowel bore into which the measuring dowel is inserted.

8. The support jack according to claim 6, wherein the recess is arranged in one of the bearing pins or the axle tube.

9. The support jack according to claim 8, wherein the recess is aligned in the axial direction of the bearing pin the axle tube.

10. The support jack according to claim 8, wherein the recess is arranged eccentrically to a center axis (x) of the bearing pin or the axle tube, on a side facing away from the outer and/or inner tube.

11. The support jack according to claim 8, wherein the recess is formed as a blind hole on a front side of the bearing pin or the axle tube.

12. The support jack according to claim 11, wherein the pin-shaped force measuring element is inserted into the borehole deepest of the blind hole.

13. The support jack according to claim 8, wherein the support foot has a base plate, on which two wall sections are formed projecting laterally with respect to the inner tube, wherein a bearing opening is formed in the wall sections for receiving the bearing pins or the axle tube, at least a section of the pin-shaped force measuring element being arranged between the adjacent wall section and a downwardly projected plane (y) of the inner tube.

14. The support jack according to claim 1, wherein the force measuring element is a strain gauge application.

15. The support jack according to claim 14, wherein the strain gauge application is applied to an upper and/or lower side of the main body.

16. The support jack according to claim 14, wherein the strain gauge application is applied to the axle tube.

17. The support jack according to claim 2, wherein the foot receiving element has a main body, with which the foot receiving element is fastened to the inner tube, and two bearing pins projecting on opposite sides of the main body, wherein the foot receiving element has an axle tube which projects laterally beyond the inner tube and to which the support foot is pivotally attached, and wherein the force measuring element is attached to the main body, to one of the bearing pins or the axle tube.

18. The support jack according to claim 17, wherein the force measuring element is pin-shaped and is inserted into a complementary shaped recess of the foot receiving element without play or under prestress, wherein the pin-shaped force measuring element is a measuring dowel and the recess is a measuring dowel bore into which the measuring dowel is inserted and wherein the recess is arranged in one of the bearing pins or the axle tube.

19. The support jack according to claim 18, wherein the recess is aligned in the axial direction of the bearing pin or the axle tube, wherein the recess is arranged eccentrically to a center axis (x) of the bearing pin or the axle tube, on a side facing away from the outer and/or inner tube, and wherein the recess is formed as a blind hole on a front side of the bearing pin or the axle tube.

20. The support jack according to claim 11, wherein the pin-shaped force measuring element is inserted into the borehole deepest of the blind hole, and wherein the support foot has a base plate, on which two wall sections are formed projecting laterally with respect to the inner tube, wherein a bearing opening is formed in the wall sections for receiving the bearing pins or the axle tube, at least a section of the pin-shaped force measuring element being arranged between the adjacent wall section and a downwardly projected plane (y) of the inner tube.
